(19) United States
(12) Patent Application Publication
(10) Pub. No.: US 2025/0246718 A1
(43) Pub. Date: Jul. 31, 2025

(54) THERMAL MANAGEMENT SYSTEMS FOR MANAGING BOTH CONVECTIVE AND CONDUCTIVE HEAT TRANSFER WITHIN TRACTION BATTERY PACKS

(71) Applicant: FORD GLOBAL TECHNOLOGIES, LLC, Dearborn, MI (US)

(72) Inventors: Nathan LEE, Novi, MI (US); Wen DAI, Northville, MI (US); Nan ROBARGE, Saline, MI (US); Foo Chern TING, Canton, MI (US); Adam DENLINGER, Saline, MI (US)

(21) Appl. No.: 18/425,092

(22) Filed: Jan. 29, 2024

(51) Int. Cl. H01M 10/6568; H01M 10/613; H01M 10/625; H01M 10/647; H01M 10/658; H01M 50/211; H01M 50/249

(52) U.S. Cl. CPC H01M 10/6568; H01M 10/613; H01M 10/625; H01M 10/647; H01M 10/658; H01M 50/211; H01M 50/249; H01M 2220/20

(57) ABSTRACT

Thermal management systems are provided for managing thermal energy in a traction battery pack. An exemplary thermal management system may utilize a combination of immersion cooling for limiting convective heat transfer and thermal barriers for limiting conductive heat transfer across one or more cell stacks of the traction battery pack. The immersion cooling may provide an edge cooling scheme in which coolant is directed across minor side surfaces (e.g., top, bottom, and ends) of battery cells of the cell stacks but does not contact major side surfaces (e.g., faces) of the battery cells. The thermal barriers may include a single layer or multiple layers of one or more thermally resistant materials (e.g., mica, aerogel, etc.).

### TECHNICAL FIELD

This disclosure relates generally to traction battery packs, and more particularly to thermal management systems for managing thermal energy levels within traction battery packs by controlling convective and conductive heat transfer.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a first group of battery cells, a second group of battery cells, and a thermal barrier arranged between the first group of battery cells and the second group of battery cells. An immersion thermal management system is configured to circulate a coolant that directly contacts the first group of battery cells and the second group of battery cells. When a battery cell of the first group or the second group releases a vent byproduct, the thermal barrier is configured to limit a conductive transfer of thermal energy between the first group and the second group, and the coolant is configured to limit a convective transfer of thermal energy resulting from the release of the vent byproduct.

In a further non-limiting embodiment of the foregoing traction battery pack, the coolant is a dielectric fluid.

In a further non-limiting embodiment of either of the foregoing traction battery packs, the first group of battery cells and the second group of battery cells each includes four battery cells.

In a further non-limiting embodiment of any of the foregoing traction battery packs, the first group of battery cells and the second group of battery cells each includes two battery cells.

In a further non-limiting embodiment of any of the foregoing traction battery packs, each battery cell of the first group of battery cells and the second group of battery cells includes a first face, a second face, a first end, a second end, a top side, and a bottom side.

In a further non-limiting embodiment of any of the foregoing traction battery packs, the first face and the second face establish major side surfaces of the battery cell, and the first end, the second end, the top side, and the bottom side establish minor side surfaces of the battery cell.

In a further non-limiting embodiment of any of the foregoing traction battery packs, the coolant directly contacts the minor side surfaces but does not directly contact the major side surfaces.

In a further non-limiting embodiment of any of the foregoing traction battery packs, a coolant flow path of the coolant extends through a first compartment that extends between the top side of battery cell and a first portion of a support structure of the cell stack.

In a further non-limiting embodiment of any of the foregoing traction battery packs, the coolant flow path extends through a second compartment that extends between the bottom side of the battery cell and a second portion of the support structure of the cell stack.

In a further non-limiting embodiment of any of the foregoing traction battery packs, the coolant flow path extends through a third compartment that extends between the first end of the battery cell and a third portion of the support structure of the cell stack.

In a further non-limiting embodiment of any of the foregoing traction battery packs, the coolant flow path extends through a fourth compartment that extends between the second end of the battery cell and a fourth portion of the support structure of the cell stack.

In a further non-limiting embodiment of any of the foregoing traction battery packs, the thermal barrier is a multi-layered structure that includes a thermally insulating layer or layers sandwiched between a pair of cell expansion pad layers.

In a further non-limiting embodiment of any of the foregoing traction battery packs, the thermally insulating layer includes at least one mica sheet.

In a further non-limiting embodiment of any of the foregoing traction battery packs, the thermal barrier is a multi-layered structure that includes a thermally insulating pouch sandwiched between a pair of heat spreader layers.

In a further non-limiting embodiment of any of the foregoing traction battery packs, the thermally insulating pouch includes an aerogel material.

A method according to another exemplary aspect of the present disclosure includes, among other things, during a thermal event in which a battery cell of a cell stack of a traction battery pack vents a battery vent byproduct, blocking a conductive transfer of thermal energy between a first group of battery cells and a second group of battery cells of the cell stack with a thermal barrier that is disposed between the first group of battery cells and the second group of battery cells, and immersion cooling the first group of battery cells and the second group of battery cells to limit a convective transfer of thermal energy. During the immersion cooling, a coolant is directed across the first group of battery cells and the second group of battery cells.

In a further non-limiting embodiment of the foregoing method, during the immersion cooling, the coolant floods a vent of the battery cell.

In a further non-limiting embodiment of either of the foregoing methods, the thermal barrier is a multi-layered structure that includes a thermally insulating layer or layers sandwiched between a pair of cell expansion pad layers.

In a further non-limiting embodiment of any of the foregoing methods, the thermal insulating layer includes a single layer or multiple layers of mica or aerogel materials.

In a further non-limiting embodiment of any of the foregoing methods, the thermal barrier is a multi-layered structure that includes a thermally insulating pouch sandwiched between a pair of heat spreader layers.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell stack of the traction battery pack of FIG. 2.

FIG. 4 is a cross-sectional view through section 4-4 of FIG. 2 and schematically illustrates a coolant flow path of a thermal management system of the traction battery pack.

FIG. 5 illustrates select portions of a cell stack.

FIG. 6 illustrates select portions of another exemplary cell stack.

FIG. 7 illustrates select portions of yet another exemplary cell stack.

### DETAILED DESCRIPTION

This disclosure details thermal management systems for managing thermal energy in a traction battery pack. An exemplary thermal management system may utilize a combination of immersion cooling for limiting convective heat transfer and thermal barriers for limiting conductive heat transfer across one or more cell stacks of the traction battery pack. The immersion cooling may provide an edge cooling scheme in which coolant is directed across minor side surfaces (e.g., top, bottom, and ends) of battery cells of the cell stacks but does not contact major side surfaces (e.g., faces) of the battery cells. The thermal barriers may include a single layer or multiple layers of one or more thermally resistant materials (e.g., mica, aerogel, etc.). These and other features are discussed in greater detail in the following paragraphs of this detailed description.

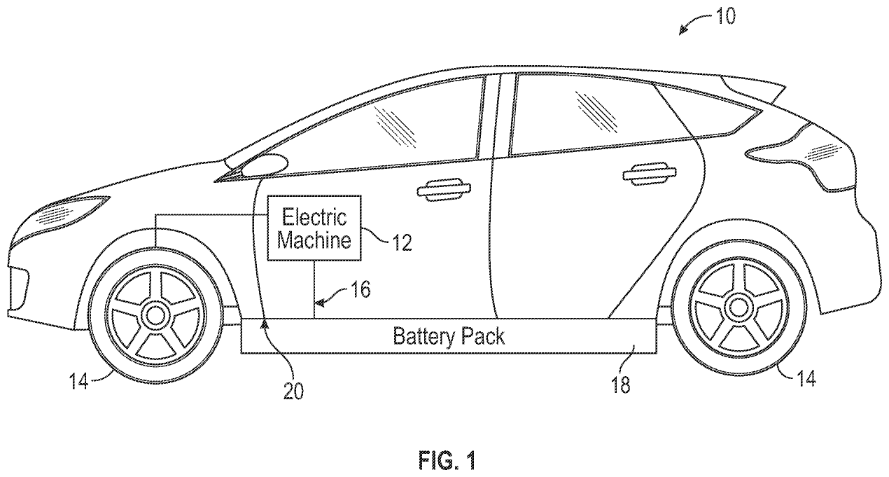

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

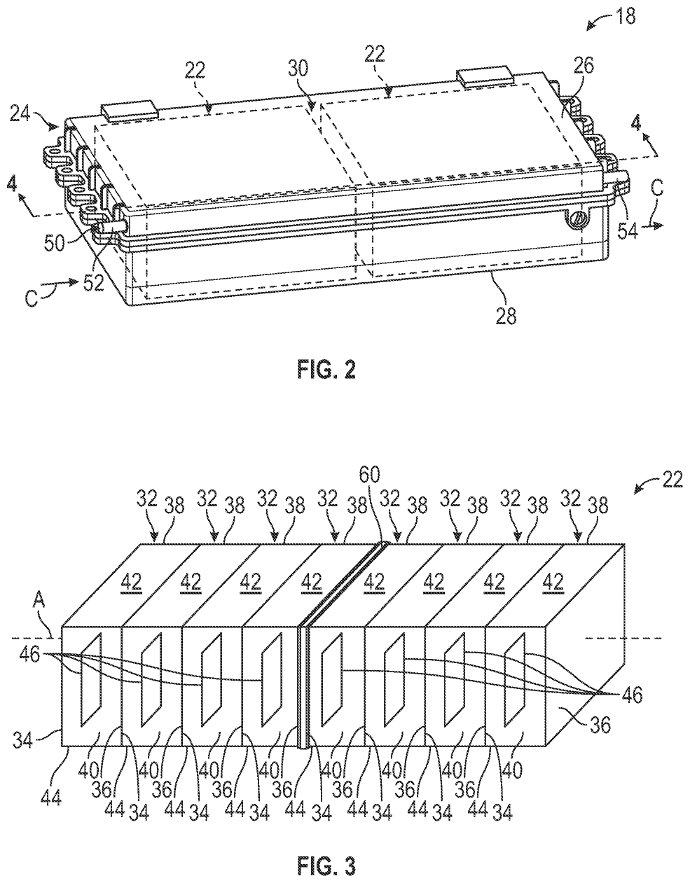

FIGS. 2, 3, and 4 illustrate additional details associated with the traction battery pack 18 of the electrified vehicle 10. The traction battery pack 18 may include one or more cell stacks 22 (e.g., two shown) housed within an interior area 30 of an enclosure assembly 24. The enclosure assembly 24 of the traction battery pack 18 may include an enclosure cover 26 and an enclosure tray 28. The enclosure cover 26 may be positioned vertically above the enclosure tray 28. However, the enclosure cover 26 could be arranged below or to a side of the enclosure tray 28. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed within the electrified vehicle 10 of FIG. 1. Vertical, for purposes of this disclosure, is also with reference to ground and how the traction battery pack 18 is oriented when installed on the electrified vehicle 10.

The enclosure cover 26 may be secured (e.g., bolted, welded, adhered, etc.) to the enclosure tray 28 to provide the interior area 30 for housing the cell stacks 22 and other battery internal components (e.g., busbars, control modules and other electronics, etc.) of the traction battery pack 18. The size, shape, and configuration of the enclosure assembly 24 may vary within the scope of this disclosure.

Each cell stack 22 may include a plurality of individual battery cells 32 (see FIG. 3). The battery cells 32 store and supply electrical power for powering various components in order to support electric propulsion of the electrified vehicle 10.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

Although a specific number of cell stacks 22 and battery cells 32 are illustrated in the various figures of this disclosure, the traction battery pack 18 could include any number of the cell stacks 22, with each cell stack 22 having any number of individual battery cells 32.

Each battery cell 32 may include a first face 34, a second face 36 opposite the first face 34, a first end 38, a second end 40 opposite the first end 38, a top side 42, and a bottom side 44 opposite the top side 42. The first face 34 and the second face 36 establish major side surfaces of the battery cells 32, and the first end 38, the second end 40, the top side 42, and the bottom side 44 establish minor side surfaces of the battery cell 32. The first face 34 and the second face 36 therefore exhibit a greater surface area than any of the first end 38, the second end 40, the top side 42, and the bottom side 44.

The battery cells 32 of each cell stack 22 may be arranged together with thermal barriers 60 along a cell stack axis A (see FIG. 3). In an embodiment, groups of four individual battery cells 32 are separated by thermal barriers 60 along the cell stack axis A. In another embodiment, the groups include single battery cells 32 separated from each other along the cell stack axis A by the thermal barriers 60. In yet another embodiment, groups of two or three individual battery cells are separated by thermal barriers 60. However, depending on various design specific requirements, the cell stacks 22 could include any number of and any arrangement of battery cells 32 and thermal barriers 60.

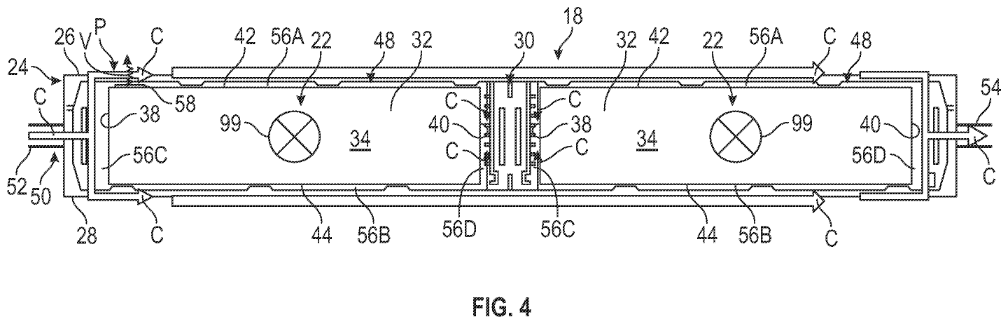

The battery cells 32 may be arranged such that the faces 34, 36 of one battery cell 32 are in direct contact with one of the faces 34 or 36 of a neighboring battery cell 32 or of a neighboring thermal barrier 60 of the cell stack 22. The battery cells 32 and thermal barriers 60 may be held in compression relative to one another within the cell stack 22 to provide the face-to-face arrangement. The compression may be applied by a support structure 48 (see FIG. 4) of the cell stack 22, for example. However, other configurations are contemplated within the scope of this disclosure. The support structure 48 may include any combination of plates, walls, crossmembers, beams, bindings, etc.

A tab terminal 46 may project outwardly from each of the first end 38 and the second end 40 of the battery cells 32. The battery cells 32 may thus be considered to be “side-oriented” within the cell stacks 22. The tab terminals 46 may be connected to busbars (not shown) in order to electrically connect the battery cells 32 of each cell stack 22.

Thermal energy levels within the battery cells 32 of each cell stack 22 can increase as the electrified vehicle 10 is operated. A thermal management system 50 can be employed for managing the thermal energy levels of the battery cells 32, cell stacks 22, and other areas of the traction battery pack 18. The thermal management system 50 may be configured to route a non-conductive coolant C over and/or around areas of each cell stack 22 to manage the thermal energy within the cell stack 22 by, for example, using the coolant C to take on heat from the cell stack 22.

The thermal management system 50 can be considered an immersion thermal management system at least because portions of the traction battery pack 18, here at least portions of the battery cells 32, can be immersed in the coolant C. Thermal energy can transfer between the coolant C and the battery cells 32 as the coolant C flows over and/or around the battery cells 32. The coolant C can help manage thermal energy levels of the battery cells 32 as well as other components of the traction battery pack 18.

The thermal management system 50 can deliver the coolant C to the interior area 30 of the traction battery pack 18 through an inlet 52. The coolant C can fill one or more open areas within the interior area 30 such that the battery cells 32 are immersed in, and directly contacted by, the coolant C within the traction battery pack 18. The coolant C can take on thermal energy from the battery cells 32 of the cell stacks 22 and other components of the traction battery pack 18 for managing the thermal energy levels.

The coolant C may exit the traction battery pack 18 through an outlet 54, which may be located at an opposite end of the enclosure assembly 24 from the inlet 52. The coolant C that exits the outlet 54 can move to a thermal energy exchange device (not shown), such as a heat exchanger, where thermal energy can be transferred from the coolant C. A pump (not shown) can be operated to selectively circulate the coolant C between the traction battery pack 18 and the thermal energy exchange device.

In an embodiment, the inlet 52 and the outlet 54 are disposed near a vertical top of the enclosure assembly 24. Such a positioning can facilitate filling the interior area 30 with the coolant C while also allowing air to escape as the level of the coolant C continues to rise during the filling. However, other inlet and outlet positions are contemplated within the scope of this disclosure.

The coolant C may be a dielectric fluid or another type of non-conductive fluid (e.g., oil) that is designed for immersion cooling the battery cells 32. However, other non-conductive fluids may also be suitable, and the actual chemical make-up and design characteristics (e.g., dielectric constant, maximum breakdown strength, boiling point, etc.) may vary depending on the environment the traction battery pack 18 is to be employed within. Unlike the conductive glycol often utilized within known traction battery pack cold plate systems, the coolant C received inside the immersion cooled cell stacks 22 of this disclosure allows for direct contact with the battery cells 32 and other electrified components without causing electrical shorts. The exemplary thermal management system 50 therefore enables high rate charging and discharging and allows for high load demands without increasing the hardware size of the cell stacks 22.

The thermal barriers 60 may also function as part of the thermal management system 50. For example, the thermal barriers 60 may be arranged to limit the conductive cell-to-cell transfer of thermal energy across each cell stack 22 of the traction battery pack 18.

Referring now primarily to FIG. 4, the thermal management system 50 may be configured to communicate the coolant C along a coolant flow path P that extends through various compartments 56 provided within the interior area 30 of the traction battery pack 18. Each compartment 56 may establish an open space for receiving the coolant C in a manner that permits direct contact with select portions of the battery cells 32. For example, first compartments 56A may extend between top sides 42 of the battery cells 32 of each cell stack 22 and a portion of the support structure 48 of the cell stack 22, second compartments 56B may extend between the bottom sides 44 of the battery cells 32 of each cell stack 22 and a portion of the support structure 48 of the cell stack 22, third compartments 56C may extend between the first ends 38 of the battery cells 32 of each cell stack 22 and a portion of the support structure 48 of the cell stack 22, and fourth compartments 56D may extend between the second ends 40 of the battery cells 32 of each cell stack 22 and a portion of the support structure 48 of the cell stack 22.

The coolant flow Path P may extend through each of the compartments 56A-56D, and thus the coolant C may be circulated through or may at least partially fill each compartment 56A-56D. The coolant C can therefore directly contact the minor side surfaces (and the tab terminals 46) of the battery cells 32 without directly contacting the major side surfaces of the battery cells 32. Due to the compression applied across each cell stack 22, the coolant C is substantially prevented (as schematically illustrated by symbol 99) from directly contacting the first and second faces 34, 36 of the battery cells 32. The thermal management system 50 is therefore considered to provide an edge cooling scheme as opposed to a face cooling scheme.

From time to time, pressure and thermal energy inside one or more of the battery cells 32 can increase. The pressure and thermal energy increase can be due to an overcharge or overdischarge condition, for example. The pressure and thermal energy increase can cause the associated battery cell 32 to rupture and expel vent byproducts V, which may include gas and debris, from within the battery cell 32. The vent byproducts V can be released from the associated battery cell 32 through a vent 58. The vent 58 may be established by a membrane that yields in response to increased pressure or through a ruptured area of the associated battery cell 32. Due to the compression applied across the cell stack 22, the associated battery cell 32 will release the vent byproducts V through one or more of the minor side surfaces of the venting battery cell 32. The process of the battery cell 32 venting the vent byproducts V may be referred to generally as a thermal event.

Because the exemplary cell stacks 22 are immersion cooled by the thermal management system 50, the vent byproducts V will move directly into the coolant C that is within one of the compartments 56. The coolant C can immediately flood the vent 58 and absorb the heat associated with the vent byproducts V and therefore limit the convective transfer of heat associated with the vent byproducts to downstream portions of the cell stacks 22, thereby better managing thermal energy levels within the traction battery pack 18. When coupled with the conductive heat transfer benefits provided by the thermal barriers 60, the thermal management system 50 can limit or even prevent thermal events from cascading to other battery cells 32 and/or other cell stacks within the traction battery pack 18.

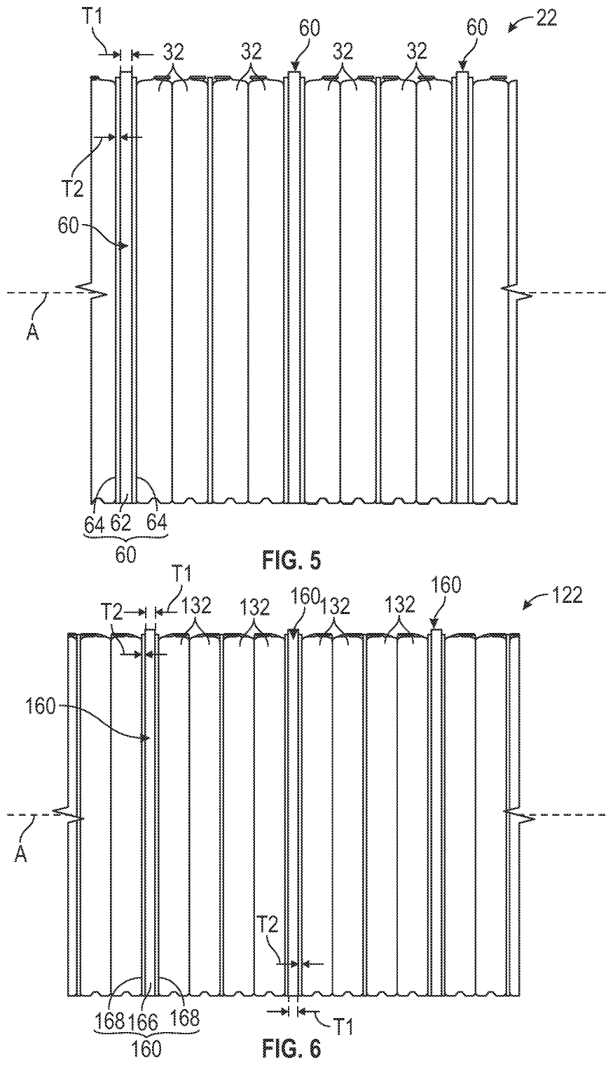

FIG. 5 illustrates select portions of one of the cell stacks 22 of the traction battery pack 18 described above. The cell stack 22 may include a thermal barrier 60 disposed between every four battery cells 32 of the cell stack 22 and arranged together along the cell stack axis A. The thermal barriers 60 may function as part of the thermal management system 50 of the traction battery pack 18.

Each thermal barrier 60 may include a multi-layered sandwich structure that is configured to limit the conductive heat transfer of thermal energy across the cell stack 22. The multi-layered sandwich structure of each thermal barrier 60 may include a thermally insulating layer 62 sandwiched between a pair of cell expansion pad layers 64.

The thermally insulating layer 62 may include a single layer or multiple layers of one or more thermally resistant (and thus low thermal conductivity) material layers such as mica, aerogel materials, refractory ceramic fibers, etc. However, other materials or combinations of materials could with utilized to provide the thermally resistant material of the thermally insulating layer 62.

Each cell expansion pad layer 64 may include a resiliently flexible or compliant material(s) for accommodating battery cell 32 swelling. The material may include polyurethane foam or silicone foam, for example. However, other materials or combinations of materials could be utilized to provide the cell expansion pads layers 64 with flexible properties within the scope of this disclosure.

In an embodiment, the thermally insulating layer 62 is made of a mica sheet that includes a first thickness T1 of about 3 mm (e.g., about 3.2 mm), and each cell expansion pad layer 64 is made of polyurethane foam and includes a second thickness T2 of about 1 mm. However, other thicknesses are contemplated within the scope of this disclosure. In this disclosure, the term “about” means that the expressed quantities or ranges need not be exact but may be approximated and/or larger or smaller, reflecting acceptable tolerances, conversion factors, measurement error, etc.

FIG. 6 illustrates select portions of another exemplary cell stack 122 that can be employed for use within the traction battery pack 18 described above. The cell stack 122 may include a thermal barrier 160 disposed between every four battery cells 132 of the cell stack 122 and arranged together along a cell stack axis A. The thermal barriers 160 may function as part of the thermal management system 50 of the traction battery pack 18 described above.

Each thermal barrier 160 may include a multi-layered sandwich structure that is configured to limit the conductive heat transfer of thermal energy across the cell stack 122. The multi-layered sandwich structure of each thermal barrier 160 may include a thermally insulating pouch 166 sandwiched between a pair of heat spreader layers 168. The thermally insulating pouch 166 may be made of a thermally resistant (and thus low thermal conductivity) material such as aerogel materials, for example. However, other materials or combinations of materials could with utilized to provide the thermally resistant material of the thermally insulating pouch 166. Each heat spreader layer 168 may be made of graphite, for example. However, other materials or combinations of materials could be utilized to provide the heat spreader layers 168.

In an embodiment, the thermally insulating pouch 166 includes a first thickness T1 of about 2 mm (e.g., about 2.4 mm), and each heat spreader layer includes a second thickness T2 of about 0.5 mm. However, other thicknesses are contemplated within the scope of this disclosure.

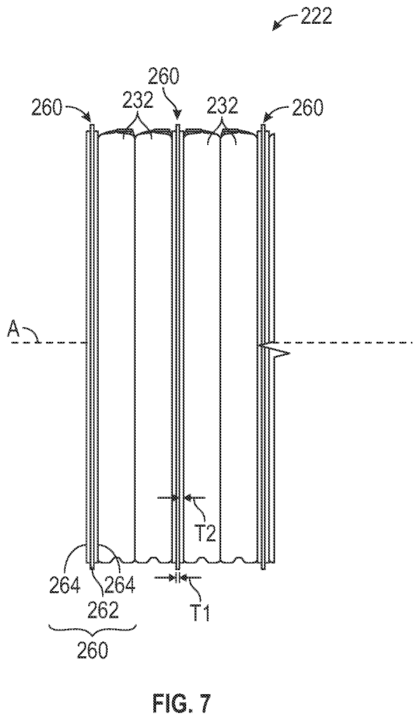

FIG. 7 illustrates select portions of another exemplary cell stack 222 that can be employed for use within the traction battery pack 18 described above. The cell stack 222 may include a thermal barrier 260 arranged between every two battery cells 232 of the cell stack 222 and disposed along a cell stack axis A. The thermal barriers 260 may function as part of the thermal management system 50 of the traction battery pack 18 described above.

Each thermal barrier 260 may include a multi-layered sandwich structure that is configured to limit the conductive heat transfer of thermal energy across the cell stack 222. The multi-layered sandwich structure of each thermal barrier 260 may include a thermally insulating layer 262 sandwiched between a pair of cell expansion pad layers 264.

The thermally insulating layer 262 may be made of a thermally resistant (and thus low thermal conductivity) material such as mica, aerogel materials, refractory ceramic fibers, etc. However, other materials or combinations of materials could with utilized to provide the thermally resistant material of the thermally insulating layer 262.

Each cell expansion pad layer 264 may include a resiliently flexible or compliant material(s) for accommodating battery cell 234 swelling. The material may include polyurethane foam or silicone foam, for example. However, other materials or combinations of materials could be utilized to provide the cell expansion pads layers 264 with flexible properties within the scope of this disclosure.

In an embodiment, the thermally insulating layer 262 is made of a mica sheet that includes a first thickness T1 of about 1 mm, and each cell expansion pad layer 264 is made of polyurethane foam and includes a second thickness T2 of about 1 mm. However, other thicknesses are contemplated within the scope of this disclosure.

The exemplary thermal management systems of this disclosure are configured to utilize a combination of immersion cooling and cell-to-cell thermal barriers for thermally managing energy levels within a traction battery pack. The proposed systems provide adequate cooling without adding volume and mass to the traction battery pack and without the need to directly cool major side surfaces of the cells.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a first group of battery cells, a second group of battery cells, and a thermal barrier arranged between the first group of battery cells and the second group of battery cells; and
an immersion thermal management system configured to circulate a coolant that directly contacts the first group of battery cells and the second group of battery cells,
wherein, when a battery cell of the first group or the second group releases a vent byproduct, the thermal barrier is configured to limit a conductive transfer of thermal energy between the first group and the second group and the coolant is configured to limit a convective transfer of thermal energy resulting from the release of the vent byproduct.

2. The traction battery pack as recited in claim 1, wherein the coolant is a dielectric fluid.

3. The traction battery pack as recited in claim 1, wherein the first group of battery cells and the second group of battery cells each include four battery cells.

4. The traction battery pack as recited in claim 1, wherein the first group of battery cells and the second group of battery cells each include two battery cells.

5. The traction battery pack as recited in claim 1, wherein each battery cell of the first group of battery cells and the second group of battery cells includes a first face, a second face, a first end, a second end, a top side, and a bottom side.

6. The traction battery pack as recited in claim 5, wherein the first face and the second face establish major side surfaces of the battery cell, and the first end, the second end, the top side, and the bottom side establish minor side surfaces of the battery cell.

7. The traction battery pack as recited in claim 6, wherein the coolant directly contacts the minor side surfaces but does not directly contact the major side surfaces.

8. The traction battery pack as recited in claim 7, wherein a coolant flow path of the coolant extends through a first compartment that extends between the top side of battery cell and a first portion of a support structure of the cell stack.

9. The traction battery pack as recited in claim 8, wherein the coolant flow path extends through a second compartment that extends between the bottom side of the battery cell and a second portion of the support structure of the cell stack.

10. The traction battery pack as recited in claim 9, wherein the coolant flow path extends through a third compartment that extends between the first end of the battery cell and a third portion of the support structure of the cell stack.

11. The traction battery pack as recited in claim 10, wherein the coolant flow path extends through a fourth compartment that extends between the second end of the battery cell and a fourth portion of the support structure of the cell stack.

12. The traction battery pack as recited in claim 1, wherein the thermal barrier is a multi-layered structure that includes a thermally insulating layer sandwiched between a pair of cell expansion pad layers.

13. The traction battery pack as recited in claim 12, wherein the thermally insulating layer includes at least one mica sheet.

14. The traction battery pack as recited in claim 1, wherein the thermal barrier is a multi-layered structure that includes a thermally insulating pouch sandwiched between a pair of heat spreader layers.

15. The traction battery pack as recited in claim 14, wherein the thermally insulating pouch includes an aerogel material.

16. A method, comprising:
during a thermal event in which a battery cell of a cell stack of a traction battery pack vents a battery vent byproduct:
blocking a conductive transfer of thermal energy between a first group of battery cells and a second group of battery cells of the cell stack with a thermal barrier that is disposed between the first group of battery cells and the second group of battery cells; and
immersion cooling the first group of battery cells and the second group of battery cells to limit a convective transfer of thermal energy,
wherein, during the immersion cooling, a coolant is directed across the first group of battery cells and the second group of battery cells.

17. The method as recited in claim 16, wherein, during the immersion cooling, the coolant floods a vent of the battery cell.

18. The method as recited in claim 16, wherein the thermal barrier is a multi-layered structure that includes a thermally insulating layer or layers sandwiched between a pair of cell expansion pad layers.

19. The method as recited in claim 18, wherein the thermal insulating layer includes a single layer or multiple layers of mica or aerogel materials.

20. The method as recited in claim 16, wherein the thermal barrier is a multi-layered structure that includes a thermally insulating pouch sandwiched between a pair of heat spreader layers.
